(19) United States
(12) Patent Application Publication
(10) Pub. No.: US 2020/0269848 A1
(43) Pub. Date: Aug. 27, 2020

(54) SYSTEM FOR ADJUSTING AND ACTIVATING VEHICLE DYNAMICS FEATURES ASSOCIATED WITH A MOOD OF AN OCCUPANT

(71) Applicant: DENSO International America, Inc., Southfield, MI (US)

(72) Inventors: Te-Ping KANG, Ann Arbor, MI (US); Yu ZHANG, Farmington Hills, MI (US); Bilal ALASRY, Dearborn, MI (US); Vikas UPMANUE, Novi, MI (US); Jordan NECOVSKI, Livonia, MI (US); Sean BLEICHER, Fenton, MI (US); Doua VANG, Waterford, MI (US)

(21) Appl. No.: 16/287,299

(22) Filed: Feb. 27, 2019

(51) Int. Cl. B60W 40/08; B60W 10/22; G06K 9/00; G06N 20/00

(52) U.S. Cl. CPC B60W 40/08; B60W 10/22; B60W 2040/0872; G06K 9/00315; G06N 20/00; G06K 9/00845

(57) ABSTRACT

A system in a vehicle, comprising one or more cameras configured to obtain facial recognition information based upon facial expressions of an occupant of the vehicle, and a controller in communication with the one or more cameras, wherein the controller is configured to determine the mood of the occupant utilizing at least the facial recognition information, and output an instruction to execute an activation or adjustment of a vehicle driving feature associated with the mood of the occupant.

### TECHNICAL FIELD

The present disclosure relates to monitoring of an occupant's mood.

### BACKGROUND

Vehicles may be configured to monitor a stress level of an occupant. Vehicles may have various features that may alternate the comfort of the ride of the vehicle. Other vehicle features may be referred to as advanced driver assistance systems (ADAS) features.

### SUMMARY

According to one embodiment, a system in a vehicle, comprising one or more cameras configured to obtain facial recognition information based upon facial expressions of an occupant of the vehicle, and a controller in communication with the one or more cameras, wherein the controller is configured to determine the mood of the occupant utilizing at least the facial recognition information, and output an instruction to execute an activation or adjustment of a vehicle driving feature associated with the mood of the occupant.

According to a second embodiment, a system in a vehicle comprising one or more microphones configured to obtain spoken dialogue from an occupant of the vehicle, a controller in communication with the one or more microphones, wherein the controller is configured to receive spoken dialogue from the microphone, determine a mood of the occupant utilizing at least the spoken dialogue, and output an instruction to execute an activation or adjustment of a vehicle driving feature associated with the mood of the occupant.

According to a third embodiment, a system in a vehicle comprising one or more sensors configured to obtain input from an occupant of the vehicle, a controller in communication with the one or more sensors, wherein the controller is configured to receive the input from the one or more sensors, determine a mood of the occupant utilizing at least the input, and output an instruction to execute an activation or adjustment of a vehicle driving feature associated with the mood of the occupant.

### BRIEF DESCRIPTION OF THE DRAWINGS

FIG. 1 illustrates an example block diagram of a vehicle system 100.

FIG. 2 illustrates an example image processing method for obtaining facial parameters from an image of a user according to this disclosure.

FIG. 3 is an exemplary flow chart 200 of an adaptive advanced driving assistance system with stress determination via a driver status monitor (DSM) and machine learning.

FIG. 4A illustrates an exemplary diagram of mood profiles for an occupant of a vehicle.

FIG. 4B illustrates an exemplary table of the mood profile corresponding to the moods and adjustment of vehicle features based on the mood.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

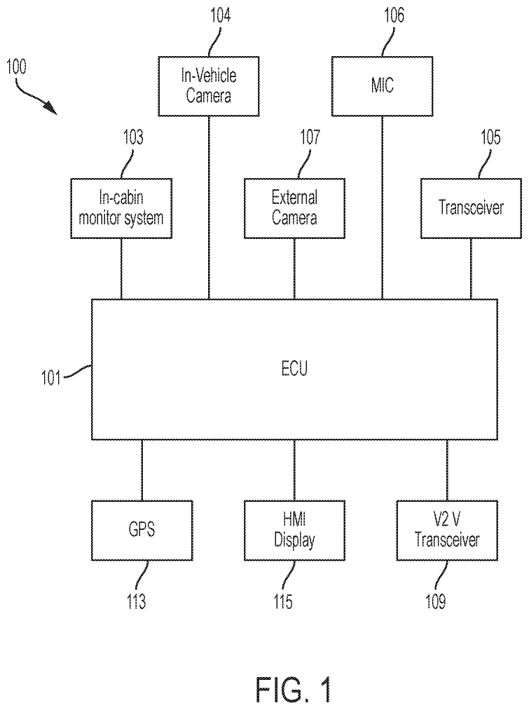

FIG. 1 illustrates an example block diagram of a vehicle system 100. The system 100 may include a controller 101. The controller 101 may be a vehicle controller such as an electronic control unit (ECU). The controller 101, also referred to herein as ECU 101, may be embodied in a processor configured to carry out instructions for the methods and systems described herein. The controller 101 may include a memory (not individually shown in FIG. 1), as well as other components specific processing within the vehicle. The controller 101 may be one or more computing devices such as a quad core processor for processing commands, such as a computer processor, microprocessor, or any other device, series of devices or other mechanisms capable of performing the operations discussed herein. The memory may store instructions and commands. The instructions may be in the form of software, firmware, computer code, or some combination thereof. The memory may be in any form of one or more data storage devices, such as volatile memory, non-volatile memory, electronic memory, magnetic memory, optical memory, or any other form of data storage device. In one example, the memory may include 2 GB DDR3, as well as other removable memory components such as a 128 GB micro SD card.

The controller 101 may be in communication with various sensors, modules, and vehicle systems both within and remote of a vehicle. The system 100 may include such sensors, such as various cameras, a LIDAR sensor, a radar sensor, an ultrasonic sensor, or other sensor for detecting information about the surroundings of the vehicle, including, for example, other vehicles, lane lines, guard rails, objects in the roadway, buildings, pedestrians, etc. In the example shown in FIG. 1, the system 100 may include an in-cabin monitor system 103, a transceiver 105, a vehicle-to-vehicle transceiver 109, a GPS module 113, a human-machine interface (HMI) display as well as other sensors, controllers, and modules. FIG. 1 is an example system and the system 100 may include more or less sensors, and of varying types. Further, while the vehicle of FIG. 1 is shown with specific sensors in specific locations for purposes of illustration, the system 100 may be equipped with additional sensors at different locations within or on the vehicle, including additional sensors of the same or different type. As described below, such sensors may be utilized to determine a cognitive load of an occupant of the vehicle.

The vehicle system 100 may be equipped with a transceiver 105. The transceiver 105 may be a BLUETOOTH transceiver. In one illustrative embodiment, the system 100 uses the BLUETOOTH transceiver 105 to communicate with a user's mobile device (e.g., cell phone, smart phone, PDA, tablet, or any other device having wireless remote network connectivity). The mobile device can then be used to communicate with a network outside the vehicle system 100 through, for example, communication with a cellular tower. In some embodiments, tower may be a WiFi access point. The mobile device could also be used to track the occupants' phone interaction (e.g. web browsing, texting).

If the user has a data-plan associated with the mobile device, it is possible that the data-plan allows for broad-band transmission and the system could use a much wider bandwidth (speeding up data transfer). In still another embodiment, mobile device is replaced with a cellular communication device (not shown) that is installed to vehicle. In yet another embodiment, the mobile device may be a wireless local area network (LAN) device capable of communication over, for example (and without limitation), an 802.11g network (i.e., WiFi) or a WiMax network. In one embodiment, incoming data can be passed through the mobile device via a data-over-voice or data-plan, through the onboard BLUETOOTH transceiver and into the vehicle's ECU 101. In the case of certain temporary data, for example, the data can be stored on the HDD or other storage media until such time as the data is no longer needed.

In another embodiment, the transceiver 105 may be on on-board communication device or cellular modem. The on-board communication device may not require a cellular phone (e.g. mobile device) to be paired with a BLUETOOTH transceiver to communicate to an off-board server. Instead, the on-board modem may have its own capability to communicate with an off-board network.

An in-cabin monitor system 103 may include a driver status monitoring system (DSM) and an occupant monitoring system (OMS). In another embodiment, the DSM may focus on both the driver and occupants. The DSM may be focused on the primary occupant who is making driving maneuver decisions. OMS may be focused on other occupants who are not involved in driving decisions. Both DSM and OMS may include in-vehicle cameras, which may be utilized to capture images of an occupant in the vehicle. The in-vehicle camera may obtain facial information about an occupant, such as eye-movement of the occupant and head-movement of the occupant, as discussed further below. The in-vehicle camera may be a color camera, infrared camera, or time of flight camera.

A controller may receive driver status data from the DSM to determine an abnormal situation within the vehicle. The DSM employs one or more activity sensors such as a driver-facing camera, a health scanner, and a driver performance evaluator to monitor activities performed by the driver. Based on the activity sensors, the driver status module may determine whether the driver is, for example, distracted, sick, or drowsy as the abnormal situation.

The DSM may be mounted at the meter console to capture the driver's face, especially the driver's eyes. The DSM module or ECU 101 may process data received from the driver-facing camera and monitors whether the driver looks away from the road based on the driver's gaze direction. If the driver looks away, the driver status module or ECU 101 determines the abnormal situation. The driver status module or ECU 101 may also determine whether the driver is drowsy or alert based on how much the driver's eye opens and for how long. In addition, driver status module or ECU 101 may also identify a cognitive load of the user. The driver-facing camera may be utilized for identification of a driver and utilized for possible video conferencing.

The system may include a microphone 106 that is utilized to receive input from spoken dialogue from occupants of the vehicle. The spoken dialogue may be converted to data and utilized for voice recognition commands that are determined by a voice recognition engine. Additionally, the voice recognition engine may utilize the spoken dialogue to determine fluctuations or change in the voice pitch to identify a mood. For example, the voice recognition engine may be programmed to pick up various fluctuations in the tone of voice, certain commands or sayings from the user, or other changes/characteristics in spoken dialogue to determine if a mood of the occupant has changed.

An in-vehicle camera 104 may be mounted in the vehicle to monitor occupants (e.g. a driver or passenger) within the vehicle cabin. The in-vehicle camera 104 may work with a driver status monitoring system (DSM) to monitor a driver. The in-vehicle camera 104 may be utilized to capture images of an occupant in the vehicle. The in-vehicle camera 104 may obtain facial information about an occupant, such as eye-movement of the occupant and head-movement of the occupant, as discussed further below. The in-vehicle camera may be a color camera, infrared camera, or time of flight camera.

The in-vehicle camera 104 may be mounted at the meter console to capture the driver's face, especially the driver's eyes. The driver status module or ECU 101 may process data received from the camera 104 and monitors change in facial expressions by the occupant. The driver status module or ECU 101 may also work with the in-vehicle camera 104 determine whether the driver is drowsy or alert based on how much the driver's eye opens and for how long.

A health scanner may be mounted on the steering wheel or suitable location which the driver touches. A health scanner may also use on-contact sensors such as infrared cameras. The health scanner may scan physiological features (such as heartbeat, skin conductance level, blood pressure). The DSM module or ECU 101 may process data received from the health scanner and monitors whether the driver is suffering from a severe physical condition or episode, such as a heart attack based on the heartbeat. If the driver is suffering from the serve physical condition or episode, the DSM may determine an abnormal situation. Thus, the DSM may collect stress load information by scanning the physiological features from the occupant to later be utilized to determine a stress level of the occupant.

The health scanner may include multiple sensors utilized to monitor a primary occupant or secondary occupants. The sensors may include primary occupant facing camera that is configured to capture eye movement and a facial expression of the occupant. The sensors may also include a biometric sensor for heart rate, respiration rate, blood pressure, brain activity, skin conductance level, body temperature, etc. via contact-based or non-contact-based sensors. Such sensors may be utilized to obtain stress load data from an occupant. The sensors may include a set of vehicle dynamic sensor, which collect information to assess the quality of driving or the level of maneuver difficulty based on metrics such as speed, acceleration, steering entropy. The other sensors may include whole cabin imaging monitor system to detect and predict the interaction between the primary and other occupants. The sensors may also include audio processing unit to detect and predict the interaction between the primary and other occupants. The multiple sensor includes a set of biometric sensor for heart rate, respiration rate, blood pressure, brain activity, skin conductance level, body temperature, etc. via contact-based or non-contact based sensor. The system may utilize such information to predict the needs for future interaction between the primary and other occupants, as well as be utilized for stress load information and driver distraction information. The health scanner may be part of the DSM or utilized in conjunction with the DSM.

A driver performance evaluator may assess driver performance based on the vehicle dynamic data, collected either through embedded data source (such as the CAN bus) or installed data source (such as gyroscope, etc.). The driver performance evaluator could be used decide whether a driver is sufficiently focused on the driving task or whether the driver is capable of dealing the current driving environment. The data collected from driver performance data may also be used identify a cognitive load of the user.

The vehicle system 100 may include an external driving environment monitor system (DEMS). The DEMS may include an external camera, which may be mounted in the rear-view mirror. The external camera may also be facing out of the vehicle cabin through a vehicle's windshield to collect imagery data of the environment in front of the vehicle. The external camera may be utilized to collect information and data regarding the front of the vehicle and for monitoring the conditions ahead of the vehicle. The camera may also be used for imaging the conditions ahead of the vehicle and correctly detecting the positions of lane markers as viewed from the position of the camera and the presence/absence, for example, of lighting of the head lights of oncoming vehicles. For example, the external camera may be utilized to generate image data related to vehicle's surrounding the vehicle, lane markings ahead, and other object detection. A vehicle may also be equipped with a rear camera (not shown) for similar circumstances, such as monitoring the vehicle's environment around the rear proximity of the vehicle. Such sensors may be utilized to collect driver distraction information from a surrounding of the vehicle. For example, the more vehicles identified by the external camera, the system may be utilized to calculate the driver's distraction and determine that the driver may be more distracted.

The DEMS could also include other sensors, including the LIDAR sensors, radar sensors, etc. These sensors may be mounted anywhere on the vehicle. For example, it is possible for LIDAR sensors to be mounted on a roof a vehicle with a 360-degree view of the vehicle's surrounding. Furthermore, the various sensors may surround the vehicle to provide a 360-degree view of the vehicle. The vehicle may also be equipped with one or more cameras, one or more LIDAR sensors, one or more radar sensors, one or more ultrasonic sensors, and/or one or more other environmental sensors. Actuators may be utilized to adjust or control an angle of the field of view of the various sensors. Data from these sensors may be processed through DEMS or ECU 101 to identify objects. For example, a forward LIDAR sensor and corner LIDAR sensor may be utilized. The forward LIDAR sensor may be used to determine what vehicle and objects are in the front peripheral of the vehicle. A corner LIDAR sensor may be utilized to also detect and classify objects and used to enhance a vehicle's peripheral view of the vehicle's surrounding. A corner LIDAR sensor may be utilized to also detect and classify objects and used to enhance a vehicle's peripheral view of the vehicle's surrounding.

The forward radar sensor may be mounted in the front bumper of the vehicle. The corner radar sensor may be mounted in the corner of the bumper. Radar sensors may be configured to detect and classify objects to enhance a vehicle's peripheral view of the vehicle's surrounding. The radar sensors may be utilized to help or enhance various vehicle safety systems. The forward radar sensor may be built into a front bumper of the vehicle to determine that an object is ahead of the vehicle. The corner radar sensor may be located in the rear bumper or the side of the vehicle. The corner radar sensor may be utilized to determine if objects are in a driver's blind spot, as well as detecting vehicles or objects approaching from the rear on the left and right when reversing. Such functionality may allow a driver to navigate around other vehicles when changing lanes or reversing out of a parking space, as well as assist in autonomous emergency braking in order to avoid collisions that may be imminent.

The system 100 may also include a vehicle-to-vehicle or vehicle-to-infrastructure communication module (e.g. V2X module) 109. The V2X module 109 may be utilized to send and receive data from objects proximate to the vehicle. Such data may include data regarding the environment surrounding the vehicle or information about the object that the vehicle is communicating with utilizing the V2X module. In one scenario, the V2X module 109 might recognize non-line-of-sight hazards which will influence the current driving session. Such information may be utilized for driver distraction. The ECU 101 may determine the situation could become challenging soon for the driver to use an HMI presentation with a given level of complexity.

The system 100 may also include a global positioning system (GPS) 113 that detects or determines a current position of the vehicle. In some circumstances, the GPS 113 may be utilized to determine a speed that the vehicle is traveling. The system 100 may also include a vehicle speed sensor (not shown) that detects or determines a current speed that the vehicle is traveling. The system 100 may also include a compass or three-dimensional (3D) gyroscope that detects or determines a current direction of the vehicle. Map data may be stored in the memory. The GPS 113 may update the map data. The map data may include information that may be utilized with advanced driver assistance system (ADAS). Such ADAS map data information may include detailed lane information, slope information, road curvature data, lane marking-characteristics, etc. Such ADAS map information may be utilized in addition to traditional map data such as road names, road classification, speed limit information, etc. The controller 101 may utilize data from the GPS 113, as well data/information from the gyroscope, vehicle speed sensor, and map data, to determine whether a location or current position of the vehicle are suitable to use an HMI presentation with a given level of complexity.

The system 100 may also include a human-machine interface (HMI) display 115. The HMI display 115 may include any type of display within a vehicle cabin. Such HMI displays may include a dashboard display, navigation display, multimedia display, heads-up display, thin-film transistor liquid-crystal display (TFT LCD), etc. The HMI display 115 may also be connected to speakers to output sound related to commands or the user interface of the vehicle. The HMI display 115 may be utilized to output various commands or information to occupants (e.g. driver or passengers) within the vehicle. For example, in an automatic braking scenario, the HMI display 115 may display message that the vehicle is prepared to brake and provide feedback to the user regarding the same. The HMI display 115 may utilize any type of monitor or display utilized to display relevant information to the occupants. The HMI display 115 may also include a heads-up display (“HUD”) that is utilized to display an interface and other objects on a windshield so that the images are within a driver's periphery while driving.

The center controller panel or a remote controller may be mounted interior of the vehicle to control various vehicle systems. For example, the center controller panel or a remote controller could control an air conditioner, a music player, a video player, and a GPS navigation. The driver status module processes data received from the center controller panel or a remote controller and monitors whether the driver is distracted by non-driving tasks and his/her level of engagement on secondary task. A center controller panel may include a touch screen interface, knobs, buttons and other types of interaction method. A remote controller may be located at the steering wheel, in front of arm rest or other locations that accessible to the user. A remote controller may include touch-pads, knobs, buttons and other types of interaction method. For example, when the center controller panel or a remote controller is being operated as the vehicle is traveling, the driver is involved in secondary tasks that are potentially distracting the driver. If the driver is distracted, the driver status module ECU may determine the abnormal situation.

In addition to providing visual indications, the HMI display 115 may also be configured to serve as the center controller panel, receiving user input via a touch-screen, user interface buttons, etc. The HMI display 115 may be configured to receive user commands indicative of various vehicle controls such as audio-visual controls, autonomous vehicle system controls, certain vehicle features, cabin temperature control, etc. The controller 101 may receive such user input and in turn command a relevant vehicle system of component to perform in accordance with the user input.

The controller 101 can receive information and data from the various vehicle components including the in-cabin monitor system 103, the DSM 107, the GPS 113 and the HMI display 115. The controller 101 utilize such data to provide vehicle functions that may relate to driver assistance, or autonomous driving. For example, data collected by the in-cabin monitor system 103 and the DSM 107 may be utilized in context with the GPS data and map data to provide or enhance functionality related to adaptive cruise control, automatic parking, parking assist, automatic emergency braking (AEB), etc. The controller 101 may be in communication with various systems of the vehicle (e.g. the engine, transmission, brakes, steering mechanism, display, sensors, user interface device, etc.). For example, the controller 101 can be configured to send signals to the brakes to slow the vehicle 100, or the steering mechanism to alter the path of vehicle, or the engine or transmission to accelerate or decelerate the vehicle. The controller 101 can be configured to receive input signals from the various vehicle sensors to send output signals to the display device, for example. The controller 101 may also be in communication with one or more databases, memory, the internet, or networks for accessing additional information (e.g. maps, road information, weather, vehicle information). The controller may also be utilized with the in-cabin monitor system 103 to identify facial features of an occupant of the vehicle, as explained in more detail below.

Active suspension may be a type of automotive suspension that controls the vertical movement of the wheels relative to the chassis or vehicle body with an onboard system, rather than a passive suspension where the movement is being determined entirely by the road surface. Active suspensions may include pure active suspensions and adaptive/semi-active suspensions. While adaptive suspensions only vary shock absorber firmness to match changing road or dynamic conditions, active suspensions may use some type of actuator to raise and lower the chassis independently at each wheel. Such features may allow car manufacturers to achieve a greater degree of ride quality and car handling by keeping the tires perpendicular to the road in corners, allowing better traction (engineering) and control. An onboard computer may also detect body movement from sensors throughout the vehicle and, using data calculated by opportune control techniques, controls the action of the active and semi-active suspensions. The system may virtually eliminate body roll and pitch variation in many driving situations including cornering, accelerating, and braking.

The system may utilize the DSM to identify different types of driving characteristics and attribute a driving profile to those drivers. The various driver profiles may be utilized to identify a mood of the driver. In one scenario, the system may recognize that the driver is a calm driver. The system may utilize the sensors to determine whether the calm driver is focused and relaxed. The calm driver may be one profile that is labeled by the DSM system. In another scenario, the system may recognize that the driver is a nervous driver. The nervous driver may be identified due to sensors focusing on facial recognition, sound recognition (e.g. change of pitch of voice), and/or blood pressure/pulse. The nervous driver may be another profile that is labeled by the DSM system. In another scenario, the system may recognize that the driver is a distracted and/or emotional driver. The DSM may utilize the facial recognition cameras to identify that a driver is not keeping their eyes on the roads. Additionally, the DSM may utilize sensors on the steering wheel to identify that the user may not be placing their hands on the steering wheel. The facial recognition engine may be able to identify how a user appears during “normal” days compared to “busy” days, such as eye-lid change and behavior.

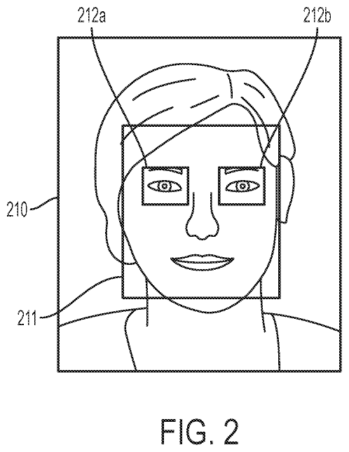

FIG. 2 illustrates an example image processing method for obtaining facial parameters from an image of a user according to this disclosure. The image processing method is used to obtain a facial parameter related to the user eye area, as described above with reference to the flow chart shown in FIG. 2, or is used to obtain other types of facial parameter.

As shown in FIG. 2, the image 210 is processed using a face detection algorithm to detect a face area 211 within the image, and to detect eye areas 212a, 212b within the face area 211. The pixels within the eye areas 212a, 212b then are analyzed to obtain a value of the facial parameter, as described herein.

Other examples of facial parameters that are detected from the captured image 210 include, but are not limited to, a distance parameter relating to a distance between the occupant and the display, one or more demographic parameters relating to the occupant, and a glasses parameter indicating whether the occupant is wearing glasses. The distance parameter may be used to determine whether the occupant is too close or too far from the display, either of which indicate that the occupant is experiencing viewing difficulty.

In some embodiments, a face recognition algorithm is used to detect certain types of expression or facial movements that indicate a mood of the occupant. For example, frowning, or wrinkling of the skin near the eyes may indicate a sign that the occupant is in an unsuitable mood. In such embodiments, the facial parameter includes one or more flags for different predefined facial characteristics that are indicative of a user experiencing an unsuitable mood. The value of a flag is set to ‘TRUE’ if that facial characteristic has been detected, and it is determined that the occupant is experiencing an unsuitable mood if a threshold number (such as one or more) of the flags in the facial parameter are set to ‘TRUE’. For example, the facial parameter includes two flags relating to frowning, squinting, and wrinkling near the eyes, and if both flags are ‘TRUE’ it is determined that the user is experiencing an unsuitable mood.

In another embodiment, smiling or eyes being wide open may indicate a sign that the occupant is in a suitable mood. In such embodiments, the facial parameter includes one or more flags for different predefined facial characteristics that are indicative of a user experiencing a positive mood. The value of a flag is set to ‘TRUE’ if that facial characteristic has been detected, and it is determined that the occupant is experiencing a positive mood if a threshold number (such as one or more) of the flags in the facial parameter are set to ‘TRUE’. For example, the facial parameter includes two flags relating smiling and eyes opening up, and if both flags are ‘TRUE’ it is determined that the user is experiencing a suitable mood.

Demographic parameters may also be utilized to help identify a mood of the user with considering other factors that may help better identify a mood of the user. The demographic parameters or data may include, for example, estimates of the occupant's age, gender, or race. Such parameters or data may be used to determine whether the user falls into any demographic categories associated with more likelihood of facing an unsuitable mood.

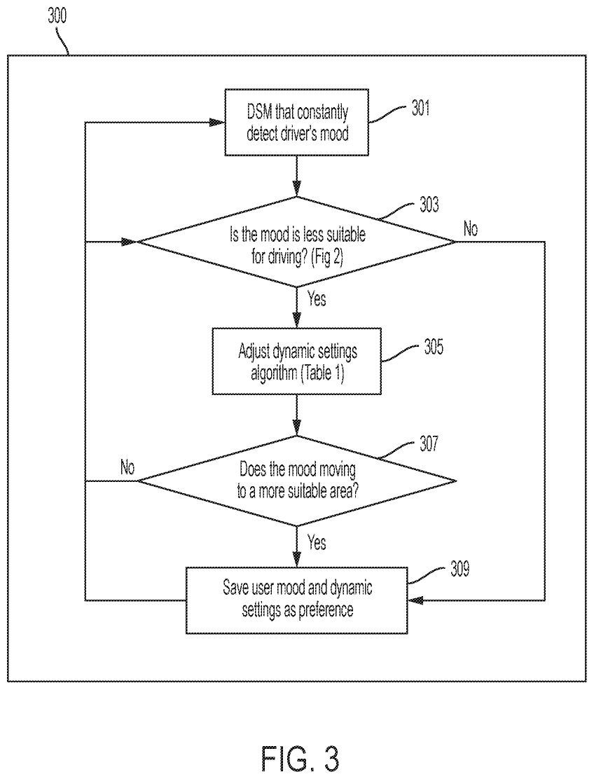

FIG. 3 is an exemplary flow chart 300 of an adaptive advanced driving assistance system with stress determination via a driver status monitor (DSM) and machine learning. At step 301, the system may utilize a DSM that constantly detects the driver's mood. The system may utilize facial recognition cameras or other sensors to identify a mood of the user. For example, the facial recognition camera may detect smiling or other facial expressions to utilize such information to determine a mood of the occupant. The system may collect the facial recognition data and voice recognition data over time to identify and establish a normal mood for the user. For example, the system may collect such information (facial recognition and voice recognition data) over a two-week period of driving to identify a stable mood of the occupant.

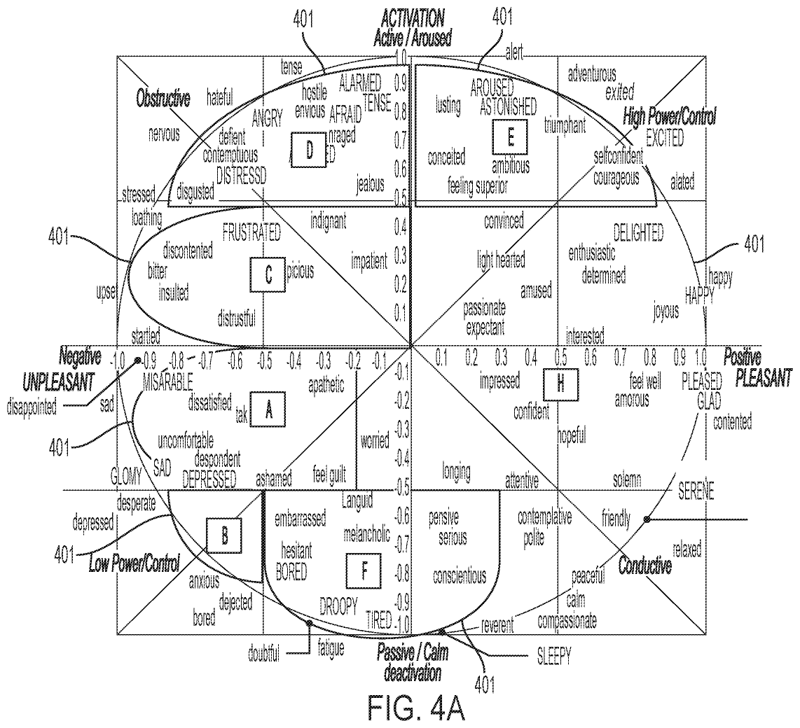

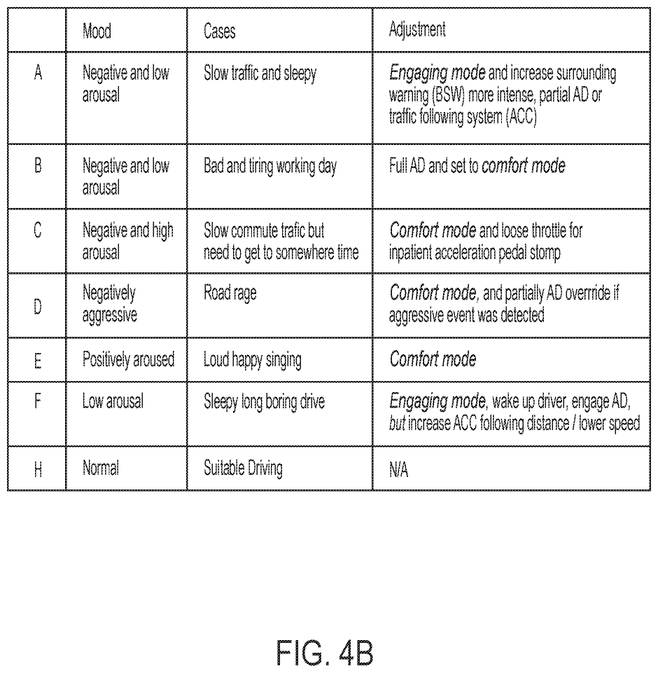

At decision 303, the system may determine if the mood if less suitable for driving. As shown and discussed further in FIG. 4A below, the system may have defined moods that are utilized based on the data collected from various sensors in the vehicle, such as the camera (e.g. facial recognition) and voice recognition system (e.g. microphone and voice recognition engine). The system may begin activation based on subtle and progressive changes within a safe driving condition of the occupant upon identifying a less than optimal mood (as opposed to an emergency situation).

At step 305, the system may adjust the dynamics settings algorithm. The settings may be adjusted by utilizing a look-up table that defines activation and adjustment of certain settings as associated with a mood of the occupant. The system may identify a user and an associated mood and compare from the historic database for the user to calibrate to a proper category. Once the associated mood is properly decided, the dynamic setting will be decided to activate upon how far away a user's mood is away from the optimal mood. For example, the predefined B area of FIG. 4A will have a more aggressive adjustment to the dynamic setting compared to predefined A or F area of FIG. 4A.

At decision 307, the system may determine if the mood is moving to a more suitable area. The system may be constantly evaluating the occupant's mood utilizing either facial recognition data or speech dialogue information to determine the mood of the occupant. The system may compare the mood of the occupant before and after activation or adjustment. The system may utilize the comparison to determine the effectiveness of improving a mood of the occupant. The mood detection may be related to comfort and non-safety of an occupant as opposed to dealing with critical conditions of the occupant.

At step 309, the system may save the user mood and dynamic settings based on a customized preference. The system may utilize have a preference to adjust a setting based on a mood. The system may utilize historical data that compares a change of the occupant's mood and adjustment of the vehicle features to identify a success rate of the features. For example, for each mood or cluster identified in FIG. 4A, the system may monitor whether or not the vehicle adjustment helped to improve the mood of the user. The system may save the types of adjustment/activation of vehicle features that helped improve the mood of the user. Thus, the system may revert to adjustment/activation of that feature when the occupant experiences that mood again as a first attempt to improve the mood of the user.

FIG. 4A illustrates an exemplary diagram of mood profiles for an occupant of a vehicle. FIG. 4A illustrates various moods and corresponding cluster 401 associated with the moods. There may be several moods that are found in a cluster 401. For example, a cluster A may show several moods that characterize the driver as miserable, dissatisfied, worried, sad, etc. The cluster A may be associated with “negative and low arousal.” Within a cluster 401 may be various “moods” or “behavior” that are found in the cluster, as illustrated in FIG. 4A. For example, such characterizations of the mood may include miserable, dissatisfied, uncomfortable, and depressed is shown in cluster A of FIG. 4A. Each cluster is discussed in more detail below and with reference to FIG. 4A. and FIG. 4B.

FIG. 4B illustrates an exemplary table of the mood profile corresponding to the moods and adjustment of vehicle features based on the mood. The table may be indicative of how a look-up table operates when identifying a mood of a user. For example, the look-up table may have an associated adjustment based on the mood of the user. As shown in the table, the system coordinates the cluster of the mood, the associated name of the mood, the use-case of the mood, and the type of adjustment (e.g. activation or adjustment of a feature) based on the mood.

In a first cluster, Cluster A, the mood may be situated as a negative mood with low arousal. The use case of the driver may be that the surrounding vehicle environment has slow traffic and the driver is sleepy. Such characterizations of the mood may include miserable, dissatisfied, uncomfortable, depressed, etc. (as shown in FIG. 4A.). The system may utilize adjustment of various vehicle features to combat the mood of the user. For example, in Cluster A, the adjustment may include having an engagement mode that may increase surrounding warnings for the blind spot warning (BSW) system. The BSW warning may be more intense if the mood is fallen into that of Cluster A. Thus, a controller may execute instructions to be sent to a controller of the blind spot system (or another system) to intensify the warning. Another adjustment may include having partial autonomous driving (AD) or activate the traffic following system of the automated cruise control (ACC) system.

In Cluster B, the mood may be situated as a negative mood with low arousal as well. Such characterizations of the mood may include anxious, dejected, bored, etc. (as shown in FIG. 4A.). However, the use case of the driver may that the user is in a bad mood and has a tired day from work or other activities. The system may utilize adjustment of various vehicle features to combat the mood of the user. For example, in Cluster B, the adjustment may include having the vehicle enter into a fully autonomous mode. Thus, a controller may execute instructions to be sent to a controller of the autonomous drive system (or another system) to activate autonomous driving. Another adjustment may include having the vehicle suspension system set to a comfort mode.

In Cluster C, the mood may be situated as a negative mood with high arousal. Such characterizations of the mood may include frustrated, disconnected, bitter, impatient, etc. (as shown in FIG. 4A.). The use case of the driver may that the user is in a slow commute (e.g. high traffic) but the user needs to get to a destination in a timely manner. The system may utilize adjustment of various vehicle features to combat the mood of the user. For example, in Cluster C, the adjustment may include having the vehicle adjust the throttle to loosen the throttle for impatient acceleration. Thus, a controller may execute instructions to be sent to a throttle controller (or another system) to adjust a setting to loosen the throttle. Another adjustment may include having the vehicle suspension system set to a comfort mode.

In Cluster D, the mood may be situated as a negatively aggressive. Such characterizations of the mood may include angry, alarmed, tense, afraid, distressed, etc. (as shown in FIG. 4A.). The use case of the driver may be that the user is experience a “road rage” situation. The system may utilize adjustment of various vehicle features to combat the mood of the user. For example in Cluster D, the adjustment may include having partial autonomous driving (AD) activated. Thus, a controller may execute instructions to be sent to an autonomous drive controller (or another system) to activate or adjust the autonomous driving mode for partial activation. Another adjustment may include having the vehicle suspension system set to a comfort mode.

In Cluster E, the mood may be situated as positively aroused. Such characterizations of the mood may include conceited, self-confident, courageous, etc. (as shown in FIG. 4A.). The use case of the driver may be that the user is loud, happy, or signing. The system may utilize adjustment of various vehicle features to adjust for the mood of the user. For example, in Cluster E, the adjustment may include may include having the vehicle suspension system set to a comfort mode. Thus, a controller may execute instructions to be sent to a vehicle suspension controller (or another system) to activate or adjust the suspension for a comfort mode.

In Cluster F, the mood may be situated as the user having low arousal. Such characterizations of the mood may include bored, droopy, tired, sleepy, serious, etc. (as shown in FIG. 4A.). The use case of the driver may be that the user is sleepy or a user experiencing a long boring drive. The system may utilize adjustment of various vehicle features to adjust for the mood of the user. For example, in Cluster F, the adjustment may include may include having the vehicle suspension system set to an engaging mode. Thus, a controller may execute instructions to be sent to a vehicle suspension controller (or another system) to activate or adjust the suspension for an engagement mode. The system may also output a warning to alert the driver or increase the ACC following distance, or lower the speed that the host vehicle follows during activation of the ACC system.

In Cluster H, the mood may be situated as normal/happy driving. Such characterizations of the mood may include passionate, pleased, calm, serene, etc. (as shown in FIG. 4A.). The use case of the driver may be that the user is having suitable driving (e.g. a normal situation). In such a scenario, the driver may not need an adjustment. Thus, the system may realize that the driver is in a normal situation and will not make any adjustment to any features to disrupt the mood of the driver.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system in a vehicle, comprising:
one or more cameras configured to obtain facial recognition information based upon facial expressions of an occupant of the vehicle;
a controller in communication with the one or more cameras, wherein the controller is configured to:
determine a mood of the occupant utilizing at least the facial recognition information; and
output an instruction to execute an activation or adjustment of a vehicle driving feature associated with the mood of the occupant.

2. The system of claim 1, wherein the controller is configured to output the instruction in response to utilizing a look-up table defining the activation or adjustment of the vehicle driving features associated with the mood of the occupant.

3. The system of claim 1, wherein the system further includes one or more voice recognition engines configured to obtain speech information from the occupant and utilize at least the speech information to determine the mood of the occupant.

4. The system of claim 1, wherein the activation of the vehicle driving feature includes activation of an autonomous driving system of the vehicle.

5. The system of claim 1, wherein the activation of the vehicle driving feature includes activation of a lane keep assist system of the vehicle.

6. The system of claim 1, wherein the activation of the vehicle driving feature includes activation of an automated cruise control system of the vehicle.

7. The system of claim 1, wherein the controller is configured to end the activation or adjustment of the vehicle driving feature upon the system determine a second mood of the occupant utilizing at least the mood-related data.

8. The system of claim 1, wherein the adjustment of the vehicle driving feature includes adjusting a suspension mode of the vehicle.

9. The system of claim 1, wherein the activation or adjustment of the vehicle driving feature is in response to historical data of the mood of the occupant.

10. A system in a vehicle, comprising:
one or more microphones configured to obtain spoken dialogue from an occupant of the vehicle;
a controller in communication with the one or more microphones, wherein the controller is configured to:
receive spoken dialogue from the microphone;
determine a mood of the occupant utilizing at least the spoken dialogue; and
output an instruction to execute an activation or adjustment of a vehicle driving feature associated with the mood of the occupant.

11. The system of claim 7, wherein the controller is configured to output the instruction in response to utilizing a look-up table defining the activation or adjustment of the vehicle driving feature associated with the mood of the occupant.

12. The system of claim 7, wherein the controller is further configured to determine the mood of the occupant utilizing at least facial recognition information receive from a camera of the vehicle.

13. The system of claim 7, wherein the controller is configured to determine the mood of the occupant

14. The system of claim 10, wherein the controller the vehicle driving feature includes a suspension mode of the vehicle.

15. The system of claim 10, wherein the controller the vehicle driving feature includes an automated cruise control system of the vehicle.

16. A system in a vehicle, comprising:
one or more sensors configured to obtain input from an occupant of the vehicle;
a controller in communication with the one or more sensors, wherein the controller is configured to:
receive the input from the one or more sensors;
determine a mood of the occupant utilizing at least the input; and
output an instruction to execute an activation or adjustment of a vehicle driving feature associated with the mood of the occupant.

17. The system of claim 16, wherein the one or more sensors includes a camera and the input from the occupant includes facial recognition information.

18. The system of claim 16, wherein the one or more sensors includes a vehicle microphone and the input from the occupant includes spoken dialogue.

19. The system of claim 16, wherein the controller is configured to output the instruction in response to utilizing a look-up table defining the activation or adjustment of the vehicle driving feature associated with the mood of the occupant

20. The system of claim 16, wherein the controller the vehicle driving feature includes a suspension mode of the vehicle.
